(19) United States
(12) Patent Application Publication
(10) Pub. No.: US 2013/0317759 A1
(43) Pub. Date: Nov. 28, 2013

(54) VALVE SERVICING CONTROLLING DEVICE AND CONTROLLING METHOD

(71) Applicant: Azbil Corporation, Tokyo (JP)

(72) Inventors: Masato TANAKA, Tokyo (JP); Kenichi KIKUCHI, Tokyo (JP); Isao YAMADA, Tokyo (JP)

(73) Assignee: Azbil Corporation, Tokyo (JP)

(21) Appl. No.: 13/902,174

(22) Filed: May 24, 2013

(30) Foreign Application Priority Data
May 24, 2012 (JP) 2012-118265

(51) Int. Cl. G07C 3/00

(52) U.S. Cl. CPC G07C 3/00
USPC 702/34

(57) ABSTRACT

An evaluation indicator is calculated to determine whether or not servicing is required, from data for evaluation for a valve that is subject to servicing. An ID of the valve is recorded in a recording area AR1. A pre-servicing evaluation indicator for the valve is recorded in a recording area AR2. A post-servicing evaluation indicator for the valve is recorded in a recording area AR3. If only a pre-servicing evaluation indicator are recorded corresponding to the valve, then a status wherein the service has not been completed is presented together with the evaluation results that are indicated by these pre-servicing evaluation indicators, where if both a pre-servicing evaluation indicator and a post-servicing evaluation indicator are recorded, then a status that service has been completed is presented together with the evaluation results showing the pre-servicing evaluation indicator and the post-servicing evaluation indicator.

### CROSS REFERENCE TO RELATED APPLICATION

The present application claims priority under 35 U.S.C. §119 to Japanese Patent Application No. 2012-118265, filed May 24, 2012, which is incorporated herein by reference.

### FIELD OF TECHNOLOGY

The present invention relates to a valve servicing controlling device and controlling method for controlling the statuses before and after servicing of a valve that is subject to servicing.

### BACKGROUND

Conventionally, large numbers of valves are used in petrochemical, chemical, and other plants, and when performing periodic servicing, a large number of valves are candidates for servicing. Given this, the valve that is actually going to be serviced (such as overhauling) is selected from a large number of valves that are candidates for servicing. When determining (selecting) a valve that is going to be subjected to servicing, the party who issues the service order and the party who receives the service order have conferred based on reference data such as time of use. There have been proposals also for equipment information management systems for collecting this reference information and outputting it in the form of a report. (See, for example, Japanese Unexamined Patent Application Publication 2011-215917.)

At the time of scheduled maintenance, substantial costs are produced in valve servicing, including servicing accompanying overhauling. Because of this, servicing the valve involves an issue of a trade-off between cost of servicing (labor, replacement materials costs, and the like), and effectiveness of servicing (safety, performance, and the like).

However, the cost-versus-effectiveness checks tend to be done only haphazardly. In particular, because, when it comes to the characteristics of valves, specialized knowledge is required regarding valve maintenance, the people on the side that request the servicing do not even know how to confirm the effects. Consequently, the handling of the issue of cost versus benefits regarding servicing tends to be left to the service contractor (the side that performs the servicing), and there have been cases wherein the servicing has been remarkably inappropriate.

The present invention is to solve such problems, and an aspect thereof is to provide a valve servicing controlling device and controlling method wherein it is possible to share, between the party ordering the servicing and the service contractor, the statuses of valves before and after servicing.

### SUMMARY

The present invention, by which to achieve the above-noted aspect, includes an evaluation data acquiring unit that acquires data for evaluation for a valve that is subject to servicing, an evaluation indicator calculating unit that calculates an evaluation indicator for determining whether or not servicing is required on the valve that is subject to servicing, from the data for evaluation that has been acquired, an evaluation indicator recording unit that records, as a pre-servicing evaluation indicator, an evaluation indicator calculated for the valve that is subject to servicing in response to a pre-servicing instruction input for the valve that is subject to servicing, and records, as a post-servicing evaluation indicator, an evaluation indicator calculated for a valve that is subject to servicing in response to a post-servicing instruction input for the valve that is subject to servicing, and a servicing status presenting unit that presents a status that the servicing has not yet been completed, together with the evaluation result indicated by the pre-servicing evaluation indicator, when only the pre-servicing evaluation indicator has been recorded, and presents a status that servicing has been completed, together with the pre-servicing evaluation indicator and the post-servicing evaluation indicator, when both the pre-servicing evaluation indicator and the post-servicing evaluation indicator have been recorded.

The inventor focused on the ability to use a specific evaluation indicator as material by which to evaluate whether or not to perform valve servicing (and in particular, whether or not to overhaul), and on the ability to use the evaluation indicator in this case as an evaluation indicator that shows that there has been a transition to a status wherein servicing is not required. Moreover, the inventor noticed that in plant maintenance controlling software systems (instrument controlling systems), there are cases wherein, when controlling valve servicing, the status after servicing is not shared between the service contractor and the party ordering servicing, which has an effect on the issue of cost-versus-benefits. Given this, the inventor arrived at the concept that a system that performs control so as to always share, between the service contractor and the party ordering servicing, an evaluation indicator that shows a transition to a status wherein servicing is not required, as the statuses before and after servicing, would be effective in improving the issue of cost-versus-benefit.

Based on this technical concept, in the present invention, an evaluation indicator for determining, from evaluation data for valves that are subject to servicing, whether or not servicing is required is calculated, and, in response to an instruction input prior to servicing of a valve that is subject to servicing, an evaluation indicator that is calculated for the valve that is to be serviced is recorded as a pre-servicing evaluation indicator, and, in response to an instruction input after servicing of the valve that was subject to servicing, the evaluation indicator calculated for the valve that was subject to servicing is recorded as a post-servicing evaluation indicator. Given this, if only a pre-servicing evaluation indicator are recorded corresponding to the valve that are subject to servicing, then a status wherein the service has not been completed is presented together with the evaluation results that are indicated by these pre-servicing evaluation indicators, where if both a pre-servicing evaluation indicator and a post-servicing evaluation indicator are recorded, then a status that service has been completed is presented together with the evaluation results showing the pre-servicing evaluation indicator and the post-servicing evaluation indicator. This makes it possible for the statuses before and after servicing a valve to be shared between the party ordering the service and the service contractor, making it possible for the party that orders the service to increase the credibility of benefits versus costs, and enables the service contractor side to reduce ambiguity in maintenance responsibilities when performing service, thereby making it possible to reduce business risk.

In the present invention, if only a pre-servicing evaluation indicator are recorded corresponding to the valve that are subject to servicing, then a status wherein the service has not been completed is presented together with the evaluation results that are indicated by these pre-servicing evaluation indicators, where if both a pre-servicing evaluation indicator and a post-servicing evaluation indicator are recorded, then a status that service has been completed is presented together with the evaluation results showing the pre-servicing evaluation indicator and the post-servicing evaluation indicator, thus making it possible for the statuses before and after servicing a valve to be shared between the party ordering the service and the service contractor, making it possible for the party that orders the service to increase the credibility of benefits versus costs, and enables the service contractor side to reduce ambiguity in maintenance responsibilities when performing service, thereby making it possible to reduce business risk.

### BRIEF DESCRIPTION OF THE DRAWINGS

FIG. 1 is a configuration diagram of a system that uses an example of a valve servicing controlling device according to the present invention.

FIG. 2 is an image diagram of pre-servicing evaluation indicator and post-servicing evaluation indicator recording areas established for the individual valves that are subject to servicing.

FIG. 3 is a diagram illustrating an example of providing content that is recorded in the evaluation indicator recording portion.

FIG. 4 is a diagram illustrating an example of step-response characteristics.

FIG. 5 is a diagram for explaining the details of a control indicator in the step-response characteristics.

FIG. 6 is a diagram illustrating an example of providing content that is recorded in the evaluation indicator recording portion when using an evaluation indicator relating to step-responsiveness (when the pre-servicing evaluation indicator and the post-servicing evaluation indicator are recorded).

### DETAILED DESCRIPTION

An example according to the present invention will be explained below in detail, based on the drawings.

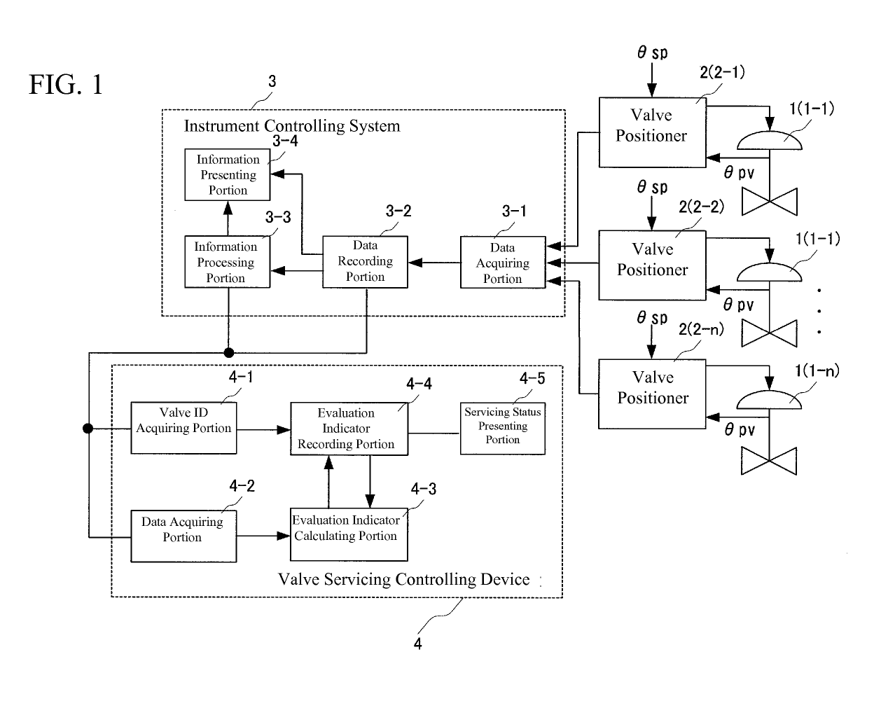

FIG. 1 is a configuration diagram of a system that uses the example of a valve servicing controlling device according to the present invention. This example is for explaining an extremely basic configuration and processing procedure.

In FIG. 1, 1-1 through 1-n are a large number of valves used in a plant, 2-1 through 2-n are positioners (valve positioners) installed in the valves 1-1 through 1-n, 3 is an instrument controlling system, and 4 is a valve servicing controlling device, according to the present invention.

In this system, a positioner 2 (2-1 through 2-n) inputs a setting opening θsp from a higher-level device (not shown), and the opening of the valve 1 (1-1 through 1-n) is controlled while monitoring the actual opening θpv, which is fed back from the valve 1 (1-1 through 1-n), so that θsp will equal θpv. Moreover, the positioner 2 (2-1 through 2-n) sends, at specific intervals, data pertaining to the control status of the valve 1 (1-1 through 1-n) to the instrument controlling system 3.

The instrument controlling system 3 is provided with a data collecting portion 3-1, a data storing portion 3-2, a data processing portion 3-3, and a data presenting portion 3-4. The data collecting portion 3-1 collects data from the positioners 2-1 through 2-n, storing it in the data storing portion 3-2. The data processing portion 3-3 performs data processing using the data that has been stored in the data storing portion 3-2, to produce secondary data. The data presenting portion 3-4 presents the data that has been stored in the data storing portion 3-2 and the data generated by the data processing portion 3-3.

The valve servicing controlling device 4 is embodied through hardware, including a processor and a storage device, and a program that achieves the various functions in cooperation with this hardware, and comprises a valve ID acquiring portion 4-1, a data acquiring portion 4-2, an evaluation indicator calculating portion 4-3, an evaluation indicator recording portion 4-4, and a service status presenting portion 4-5.

The valve servicing controlling device 4 and the instrument controlling system 3 are connected together, where data that is stored in the data storing portion 3-2 of the instrument controlling system 3 and information generated by the information processing portion 3-3 are acquired, as necessary, by the data acquiring portion 4-2 within the valve servicing controlling device 4. Additionally, the valve ID acquiring portion 4-1 within the valve servicing controlling device 4 acquires IDs of valves subject to servicing from among valves 1-1 through 1-n, with any or all of the valves 1-1 through 1-n being subject to servicing. In the explanation below, it is assumed that all of the valves 1-1 through 1-n are subject to servicing. The IDs for the valves 1-1 through 1-n are stored in the data storing portion 3-2 of the instrument controlling system 3.

Note that the valve servicing controlling device 4 according to the present invention may either be installed on the same personal computer (PC) as the PC on which, for example, the instrument controlling system 3 is installed, to share data and information, or may be installed on a separate PC, with data and information shared through a communication function.

In the below, the explanation will be for processing operations that are unique to the present example, while focusing on the functions of the various portions in the valve servicing controlling device 4.

The valve ID acquiring portion 4-1 acquires the IDs of the valves 1-1 through 1-n that are subject to servicing, and sends them to the evaluation indicator recording portion 4-4. The evaluation indicator recording portion 4-4 records the IDs of the valves 1-1 through 1-n from the valve ID acquiring portion 4-1, to set up recording areas for recording the pre-servicing evaluation indicators and the post-servicing evaluation indicators corresponding to the IDs of these valves 1-1 through 1-n. The evaluation indicator will be described hereafter.

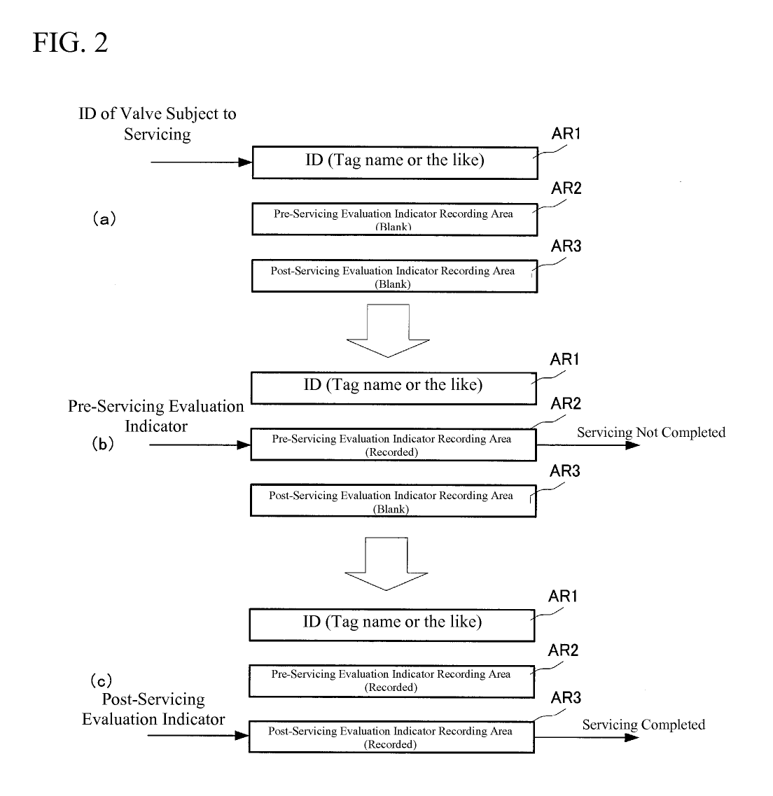

FIG. 2(a) is an image diagram of pre-servicing evaluation indicator and post-servicing evaluation indicator recording areas established for the individual valves that are subject to servicing. In this figure, AR1 is a recording area for IDs of valves that are subject to servicing, AR2 is a recording area for pre-servicing evaluation indicators, and AR3 is a recording area for post-servicing evaluation indicators. In the initial status prior to starting operations, the pre-servicing evaluation indicators in the recording area AR2 and the post-servicing evaluation indicators in the recording area AR3 are all blank. Tag names, and the like, are recorded in the recording area AR1 as IDs of the valves that are subject to servicing.

The data acquiring portion 4-2, in response to an input from an operator prior to servicing of a valve that is subject to servicing, acquires evaluation data for that valve that is subject to servicing, and sends it to the evaluation indicator calculating portion 4-3.

The evaluation indicator calculating portion 4-3 executes a calculating process for quantifying the evaluation indicator in order to determine whether or not servicing is required for that valve that is subject to servicing, from the data for evaluation for that valve that is subject to servicing, from the data acquiring portion 4-2, and sends, to the evaluation indicator recording portion 4-4, the evaluation indicator obtained thereby. In the present example, an evaluation indicator is calculated in relation to the occurrences of stick-slip as the evaluation indicator. Note that the stick-slip is disclosed in Japanese Patent 3254624, so detailed explanations thereof are omitted here.

The evaluation indicator recording portion 4-4 receives an evaluation indicator from the evaluation indicator calculating portion 4-3, confirms that the recording area AR2 for the pre-servicing evaluation indicator for the valve that will be subject to servicing is blank, and records the received evaluation indicator as pre-servicing evaluation indicator (referencing FIG. 2 (b)).

The data acquiring portion 4-2, in response to an input from an operator after servicing of a valve that is subject to servicing, acquires evaluation data for that valve that is subject to servicing, and sends it to the evaluation indicator calculating portion 4-3.

The evaluation indicator calculating portion 4-3 executes a calculating process for quantifying the evaluation indicator in order to determine whether or not servicing is required for that valve that is subject to servicing, from the data for evaluation for that valve that is subject to servicing, from the data acquiring portion 4-2, and sends, to the evaluation indicator recording portion 4-4, the evaluation indicator obtained thereby. Notes that this evaluation indicators is identical to that which was quantified and recorded prior to the servicing. That is, this is an evaluation indicator relating to the status of occurrences of stick-slip.

The evaluation indicator recording portion 4-4 receives an evaluation indicator from the evaluation indicator calculating portion 4-3, confirms that the recording area AR3 for the post-servicing evaluation indicator for the valve that will be subject to servicing is blank, and records the received evaluation indicator as post-servicing evaluation indicator (referencing FIG. 2 (c)).

The servicing status presenting portion 4-5, in response to a presentation request from an operator, presents the content that is recorded in the evaluation indicator recording portion 4-4. For example, if there is a presentation request from an operator, specifying a specific valve that is subject to service, from among the valves 1-1 through 1-n, then the content that is recorded in the evaluation indicator recording portion 4-4 for that valve that is subject to servicing will be presented.

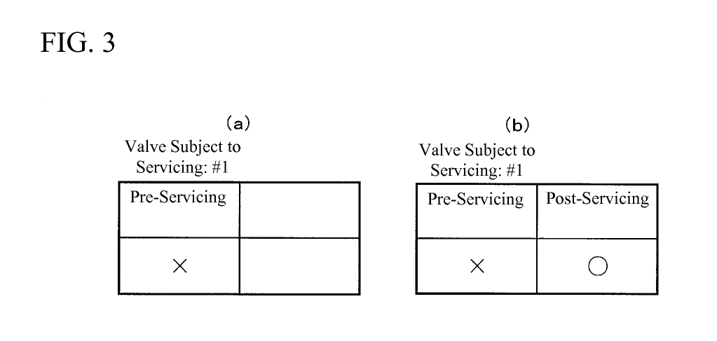

In this case, as illustrated in FIG. 2 (b), if only the pre-servicing evaluation indicator is recorded, then the status wherein servicing has not yet been completed is presented together with the evaluation result indicated by the pre-servicing evaluation indicator (referencing FIG. 3 (a)), and, as illustrated in FIG. 2 (c), if both the pre-servicing evaluation indicator and the post-servicing evaluation indicator are recorded, then the status that the servicing has been completed is presented together with the evaluation results indicated by the pre-servicing evaluation indicator and the post-servicing evaluation indicator (referencing to FIG. 3 (b)).

Note that in the example illustrated in FIG. 3 (a), because only evaluation results are shown for pre-servicing, it can be understood that the status is that servicing has not been completed, and in the example illustrated in FIG. 3 (b), because evaluation results for after servicing are displayed, it can be understood that the status is that servicing has been completed. Moreover, if the evaluation result is poor than an “X” is displayed, but if the evaluation result is good, then an “O” is displayed. The status wherein servicing has not been completed or the status wherein servicing has been completed may be indicated with a letter, or the like, or the evaluation indicator itself may be presented as the evaluation result.

The processes set forth above make it possible to share, between the party ordering servicing and the service contractor, the statuses before and after servicing of the valves 1-1 through 1-n, thus making it possible to increase the credibility of the benefits versus the costs, for the party ordering the servicing, and, for the service contractor, to reduce the ambiguity regarding the maintenance responsibilities when performing servicing, thereby making it possible to reduce business risk, when performing servicing of a valve.

For example, it is possible to perform control so as to always share, between the party ordering the servicing and the service contractor, the evaluation results that indicate a transfer to a status wherein servicing is not required (a movement into a normal operating range, specified in advance) as the post-servicing status. Moreover, if the evaluation result after servicing is that there has been no transfer to a status wherein servicing is not required, then either the servicing was inadequate or the servicing was meaningless, and in either case, this would serve as an objective indicator regarding the cost-versus-benefits. That is, there would cease to be cases wherein checking the cost versus benefits would indicate that the servicing was extremely inappropriate.

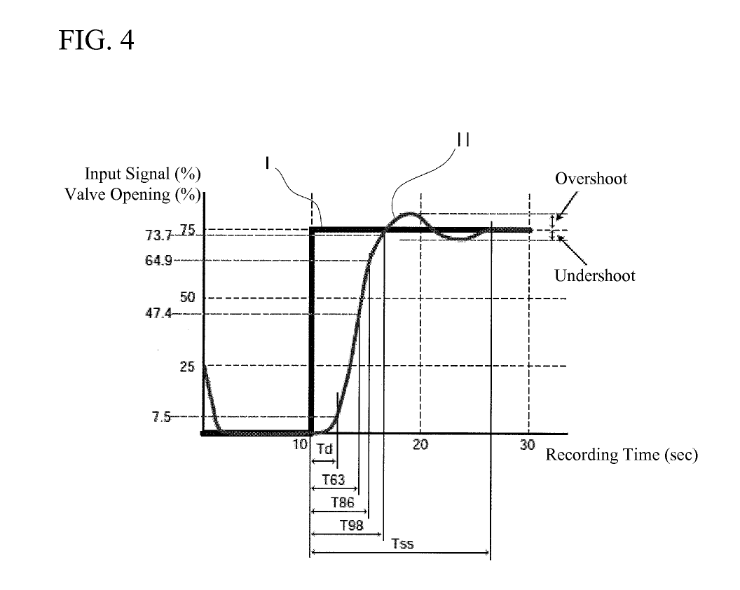

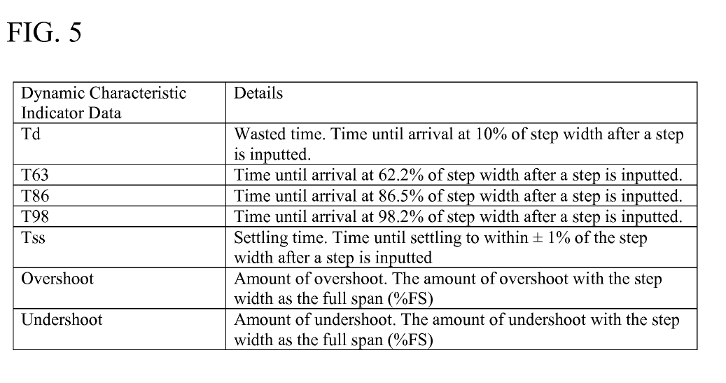

Note that while in the example set forth above the status of occurrence of stick-slip was used as the evaluation indicator, an evaluation indicator relating to step-response characteristics may be used instead. An example of step-response characteristics is illustrated in FIG. 4. In FIG. 4, I is a step-shaped input waveform, and II is the waveform of the response to the step-shaped input waveform (the step-response characteristics).The step-response characteristics include a plurality of control indicators such as the time constants Td, T63, T86, and T98, the settling time Tss, overshoot, undershoot, and the like (referencing FIG. 5), where the step-response operations for obtaining the control indicators are performed automatically off-line. Given this, at least one of these control indicators is used as an evaluation indicator, where if the evaluation indicator is in the normal operating range that is specified in advance, then the status is one wherein servicing is not required. This self-executing function is typically achieved in valve, positioner, and instrument controlling systems (known technologies), and is launched by a service technician, or the like, when servicing a valve.

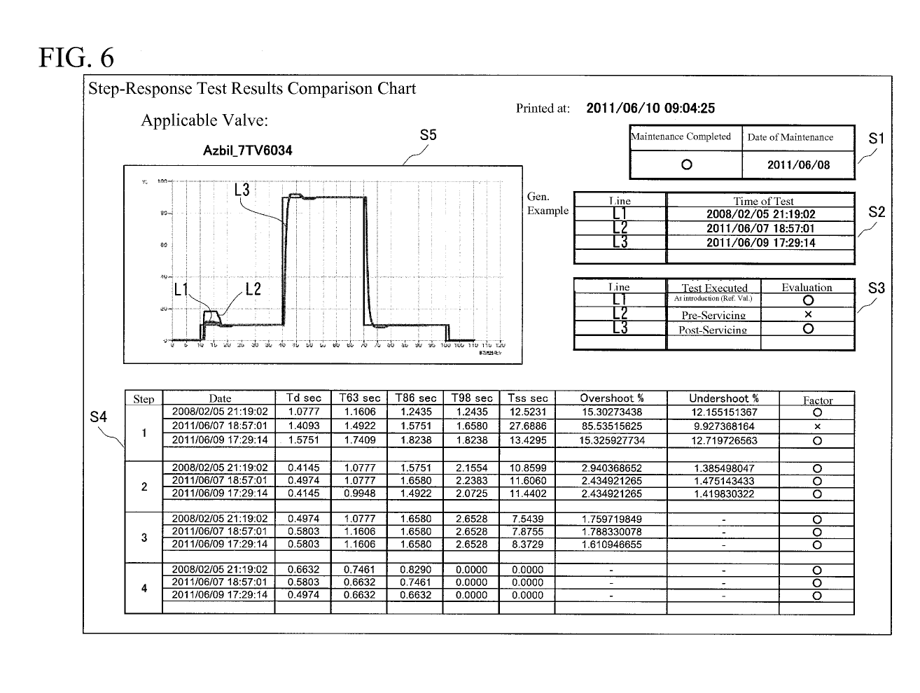

FIG. 6 illustrates an example of presenting the details recorded in the evaluation indicator recording portion 4-4 by the servicing status presenting portion 4-5 when an evaluation indicator regarding the step-response characteristics is used. This figure is an example of presentation in the case wherein the pre-servicing evaluation indicator and the post-servicing evaluation indicator are recorded.

In FIG. 6, the evaluation results at the time of introduction, at pre-servicing, and at post-servicing are displayed in the display area S3, and the servicing completion status is displayed in the display area S1. Moreover, the times at which the tests were performed at the time of introduction, at pre-servicing, and at post-servicing are displayed in the display area S2.

Note that, in FIG. 6, in the data that is displayed in the display area S4, “Date” indicates the times at which the tests were performed at the time of introduction, at pre-servicing, and at post-servicing, and “Step” indicates the number of the test cycle. For example, the “2008/02/05 21:19:02” indicates that this is an test at the time of introduction, where four cycles of step-response tests were executed in Steps 1 through 4 at the time of introduction, and the data obtained thereby were recorded. The same is true for the pre-servicing and post-servicing tests.

Moreover, in FIG. 6 an example waveform for the step-response testing is displayed in the display area S5, where the line L1 displays the response waveform at the time of introduction, shown in green, the line L2 shows the pre-servicing response waveform, displayed in blue, and the line L3 shows the post-servicing response waveform, shown in red.

### EXTENDED EXAMPLES

While the present invention has been explained above in reference to the example, the present invention is not limited to the example set forth above. The structures and details in the present invention may be varied in a variety of ways, as can be understood by one skilled in the art, within the scope of technology in the present invention. Moreover, the present invention may be embodied through combining the various forms of examples, insofar as there are no contradictions.

1. A valve servicing controlling device comprising:
an evaluation data acquiring unit that acquires data for evaluation for a valve that is subject to servicing;
an evaluation indicator calculating unit that calculates an evaluation indicator for determining whether or not servicing is required on the valve that is subject to servicing, from the data for evaluation that has been acquired;
an evaluation indicator recording unit that records, as a pre-servicing evaluation indicator, an evaluation indicator calculated for the valve that is subject to servicing in response to a pre-servicing instruction input for the valve that is subject to servicing, and records, as a post-servicing evaluation indicator, an evaluation indicator calculated for a valve that is subject to servicing in response to a post-servicing instruction input for the valve that is subject to servicing; and
a servicing status presenting unit that presents a status that the servicing has not yet been completed, together with the evaluation result indicated by the pre-servicing evaluation indicator, when only the pre-servicing evaluation indicator has been recorded, and presents a status that servicing has been completed, together with the pre-servicing evaluation indicator and the post-servicing evaluation indicator, when both the pre-servicing evaluation indicator and the post-servicing evaluation indicator have been recorded.

2. The valve servicing controlling device as set forth in claim 1, wherein
the evaluation indicator calculating unit calculates an evaluation indicator relating to the status of occurrence of stick-slip as the evaluation indicator.

3. The valve servicing controlling device as set forth in claim 1, wherein
the evaluation indicator calculating unit calculates an evaluation indicator relating to step-response characteristics as the evaluation indicator.

4. A valve servicing controlling method including:
an evaluation data acquiring step for acquiring data for evaluation for a valve that is subject to servicing;
an evaluation indicator calculating step for calculating an evaluation indicator for determining whether or not servicing is required on the valve that is subject to servicing, from the data for evaluation;
an evaluation indicator recording step for recording, as a pre-servicing evaluation indicator, an evaluation indicator calculated for the valve that is subject to servicing in response to a pre-servicing instruction input for the valve that is subject to servicing, and for recording, as a post-servicing evaluation indicator, an evaluation indicator calculated for a valve that is subject to servicing in response to a post-servicing instruction input for the valve that is subject to servicing; and
a servicing status presenting step for presenting a status that the servicing has not yet been completed, together with the evaluation result indicated by the pre-servicing evaluation indicator, when only the pre-servicing evaluation indicator has been recorded, and for presenting a status that servicing has been completed, together with the pre-servicing evaluation indicator and the post-servicing evaluation indicator, when both the pre-servicing evaluation indicator and the post-servicing evaluation indicator have been recorded.

5. The valve servicing controlling method as set forth in claim 4, wherein
the evaluation indicator calculating step calculates an evaluation indicator relating to the status of occurrence of stick-slip as the evaluation indicator.

6. The valve servicing controlling method as set forth in claim 4, wherein:
the evaluation indicator calculating step calculates an evaluation indicator relating to step-response characteristics as the evaluation indicator.
